(19) United States
(12) Patent Application Publication
(10) Pub. No.: US 2026/0018035 A1
(43) Pub. Date: Jan. 15, 2026

(54) SMART SENSORS

(71) Applicant: Alarm.com Incorporated, Tysons, VA (US)

(72) Inventors: Benjamin Asher Berg, Washington, DC (US); Aren Max Vogel, Washington, DC (US)

(21) Appl. No.: 19/262,498

(22) Filed: Jul. 8, 2025

Related U.S. Application Data
(60) Provisional application No. 63/670,176, filed on Jul. 12, 2024.

(51) Int. Cl. G08B 3/10; G01D 9/28; G08B 31/00

(52) U.S. Cl. CPC G08B 3/10; G01D 9/28; G08B 31/00

(57) ABSTRACT

Methods, systems, and apparatus, including computer programs encoded on computer storage media, for enhanced sensors. One of the methods includes accessing i) data for a detected event that was detected using first sensor data captured by a first sensor at a property and ii) second sensor data captured by a second sensor for the property, the first sensor having a different type than the second sensor; providing, to an artificial intelligence model trained to determine whether to provide a notification about the detected event, the data for the detected event and the second sensor data to cause the artificial intelligence model to generate output; receiving, from the artificial intelligence model, the output that indicates whether to provide a notification about the detected event; and performing one or more actions using the output that indicates whether to provide a notification about the detected event.

### CROSS-REFERENCE TO RELATED APPLICATION

This application claims the benefit of U.S. Provisional Application No. 63/670,176, filed Jul. 12, 2024, the contents of which are incorporated by reference herein.

### BACKGROUND

Sensors can detect various events. For instance, a water sensor can detect water, a smoke detector can detect smoke, and a motion detector can detect motion.

### SUMMARY

In general, one innovative aspect of the subject matter described in this specification can be embodied in methods that include the actions of accessing i) data for a detected event that was detected using first sensor data captured by a first sensor at a property and ii) second sensor data captured by a second sensor at the property, the first sensor having a different type than the second sensor; providing, to an artificial intelligence model trained to determine whether to provide a notification about the detected event, the data for the detected event and the second sensor data to cause the artificial intelligence model to generate output; receiving, from the artificial intelligence model, the output that indicates whether to provide a notification about the detected event; and performing one or more actions using the output that indicates whether to provide a notification about the detected event.

In general, one innovative aspect of the subject matter described in this specification can be embodied in methods that include the actions of maintaining, for an event type at a property, a prompt that represents an event subtype of the event type, a predetermined output, and data that identifies a predetermined action to perform upon detection of the event subtype; receiving, upon detection of an event of the event type using sensor data captured by a sensor at the property, the sensor data; providing, to an artificial intelligence model trained to determine whether to provide a notification about the event, the sensor data for the event and the prompt to cause the artificial intelligence model to generate output for the event subtype; receiving, from the artificial intelligence model, the output that indicates a response to the prompt; determining whether the output satisfies a similarity criterion for the predetermined output and to perform the predetermined action for the event; and performing an action using a result of the determination whether the output satisfies the similarity criterion for the predetermined output and to perform the predetermined action for the event.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

In some implementations, the method can include receiving, from the first sensor, the data for the detected event; and in response to receiving the data for the detected event, requesting the second sensor data.

In some implementations, requesting the second sensor data can include: in response to receiving the data for the detected event, triggering the second sensor to initiate capture of the second sensor data; and in response to triggering the second sensor to initiate capture of the second sensor data, receiving, from the second sensor, the second sensor data.

In some implementations, the method can include, in response to receiving the data for the detected event, determining a type of the first sensor data or a type of the event; determining whether the type satisfies a type criterion; and in response to determining that the type satisfies the type criterion, triggering the second sensor to provide the second sensor data to a system that communicates with the artificial intelligence model.

In some implementations, the method can include performing the one or more actions comprises determining to skip providing a notification in response to determining that the output indicates that a notification about the detected event should not be provided.

In some implementations, performing the one or more actions can include: determining an alert for the detected event; and sending, to a device for the property, instructions to cause the device to present the alert.

In some implementations, receiving the output can include receiving the output that indicates the alert for the detected event.

In some implementations, receiving the output can include receiving the output that indicates an audible alert for the detected event.

In some implementations, receiving the output can include receiving the output that indicates a procedurally generated alert for the detected event.

In some implementations, receiving the output can include receiving the output that indicates a predetermined alert from a plurality of predetermined alerts.

In some implementations, the method can include determining, from a plurality of presentation devices for the property, a proper subset of presentation devices for presentation of the alert. Sending the instructions can include sending the instructions to each device in the proper subset of presentation devices that includes the device.

In some implementations, receiving the output that indicates whether to provide a notification can include receiving the output that indicates the proper subset of presentation devices for presentation of the alert.

In some implementations, performing the one or more actions can include sending, to a device for the property, instructions to cause the device to perform one or more actions to mitigate a likely impact of the detected event.

In some implementations, sending the instructions can include sending, to a device, instructions to cause the device to perform at least one of shutting a water valve or turning off another device.

In some implementations, accessing the data for the detected event can include accessing the data that indicates that the detected event that likely has an environmental impact at the property. Providing the data for the detected event and the second sensor data can include providing, to the artificial intelligence model trained to determine whether to provide a notification about the detected event, the data for the detected event and the second sensor data to cause the artificial intelligence model to generate output that indicates whether to provide a notification about the detected event that likely has an environmental impact at the property. Receiving the output can include receiving, from the artificial intelligence model, the output that indicates whether to provide a notification about the detected event that likely has an environmental impact at the property.

In some implementations, a device can include both the first sensor and the second sensor.

In some implementations, the artificial intelligence model can simulate a smart sensor of the type of the first sensor.

In some implementations, the data for the detected event can include one or more of the first sensor data or event data that identifies the detected event.

In some implementations, a first process to detect the event of the event type using the sensor data can consume fewer computational resources than a second process performed by the artificial intelligence model to generate the output for the event subtype using the sensor data, and the prompt.

In some implementations, receiving the sensor data can be responsive to the sensor performing the first process to detect the event of the event type using the sensor data.

In some implementations, determining whether the output satisfies the similarity criterion for the predetermined output can include determining that the output satisfies the similarity criterion for the predetermined output and to perform the one or more actions for the event. Performing the action can include performing the predetermined action in response to determining that the output satisfies the similarity criterion for the predetermined output and to perform the one or more actions for the event.

In some implementations, determining whether the output satisfies the similarity criterion for the predetermined output can include determining that the output does not satisfy the similarity criterion for the predetermined output and to perform the one or more actions for the event. Performing the action can include performing the predetermined action in response to determining that the output does not satisfy the similarity criterion for the predetermined output and to perform the one or more actions for the event.

In some implementations, providing, to the artificial intelligence model, the sensor data and the prompt can include providing, to the artificial intelligence model, a first vector representing the sensor data and a second vector representing the prompt. Receiving, from the artificial intelligence model, the output can include receiving, from the artificial intelligence model, a third vector for the output for the event subtype that indicates the response to the prompt. Determining whether the output satisfies the similarity criterion for the predetermined output can include determining whether the third vector satisfies the similarity criterion for a fourth vector that indicates the predetermined output and to perform the predetermined action for the event.

In some implementations, the sensor data can include image data.

In some implementations, the prompt can include a question and the predetermined output comprises an answer to the question and indicates whether the sensor data is of the event subtype.

In some implementations, providing, to the artificial intelligence model, the sensor data and the prompt can include providing, to the artificial intelligence model, the sensor data for the event, the prompt, and second sensor data captured by a second sensor at the property, the sensor having a different type than the second sensor.

In some implementations, the method can include receiving, from a device, first input that defines the prompt; and receiving, from the device, second input that defines the predetermined output.

In some implementations, the method can include receiving, from a device, input that defines the prompt; and predicting, using the prompt, the predetermined output.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages. In some implementations, the systems and methods described in this specification can reduce false positive alerts, e.g., by using a combination of two or more types of sensor data to determine whether to present an alert, accessing second sensor data in response to detection of an event, or a combination of both. In some implementations, the systems and methods described in this specification can increase an accuracy of data provided about an alert, e.g., by presenting an alert using a subset of devices, presenting data with contextual mitigation actions, or a combination of both. Presenting an alert using a subset of devices can occur given the type of the alert, rooms in which people are located, rooms in which specific types of people are located, e.g., adults, or a combination of these.

In some implementations, the systems and methods described in this specification can reduce risk, e.g., by selectively determining whether to present an alert for a detected event. For instance, in some situations presentation of an alert for a detected event can cause panic, e.g., in a particular part of a building in which an alert is unnecessary; jeopardize safety; or distract a person who is working on resolving the issue that caused the event and presentation of an alert in these situations might not actually help the situation, might make the situation worse, or a combination of both. In some implementations, the systems and methods described in this specification can reduce resource usage compared to other systems, e.g., upon determining to skip presenting an alert that would otherwise always be presented upon detection of a corresponding event. The resources can be any appropriate type of resources, e.g., power, processor cycles, memory, network bandwidth, or a combination of these.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment for smart sensors.

FIG. 2 is a flow diagram of a process for determining whether to perform an action for an event.

FIG. 3 is a flow diagram of a process for determining whether to perform an action for an event using a prompt.

FIG. 4 is a diagram illustrating an example of a property monitoring system.

Like reference numbers and designations in the various drawings indicate like elements.

### DETAILED DESCRIPTION

Sensors can detect various events, such as smoke, carbon monoxide, or leaking water. These sensors make a binary decision of whether to trigger an alert. When an alert is triggered, the alert generally indicates that there is a problem, e.g., without any indication how to solve the problem.

A system can analyze data received from multiple different types of sensors to more accurately predict whether to present an alert upon detection of a triggering criterion and, if so, how to present an alert for an event. For instance, the system can determine that a smoke detector detected smoke and access image data for an area in which the smoke detector is located. The system can determine whether a person is already addressing the situation that is causing the smoke, a person should be notified about the smoke, or a combination of both.

Depending on the situation, the system can determine instructions to present about the situation, e.g., pour flour on a fire instead of water which could make the fire worse. For instance, when an adult is already addressing the situation, the system can determine to skip providing a notification, provide information about how to further address the situation, present a notification to a subset of people at the property, e.g., instead of sounding a fire alarm throughout the entire property, or a combination of these. In some situations, the notification can be presented by a device that is not at the property, e.g., when a property manager is away from the property.

The system can use an artificial intelligence model to determine whether to present an alert upon detection of a triggering condition. The artificial intelligence model can receive, as input, the sensor data, other appropriate data, or a combination of both, associated with the alert. The other appropriate data can be contextual data, e.g., additional sensor data, a prompt, or a combination of both. For instance, the input can include the sensor data and a prompt that defines an event subtype rule, e.g., when the detected event has an event type. The artificial intelligence model can predict an output for the prompt given the sensor data. If the output satisfies a predetermined output for the prompt, the system can perform a corresponding action, e.g., present a notification, unlock a door, or another appropriate monitoring system action.

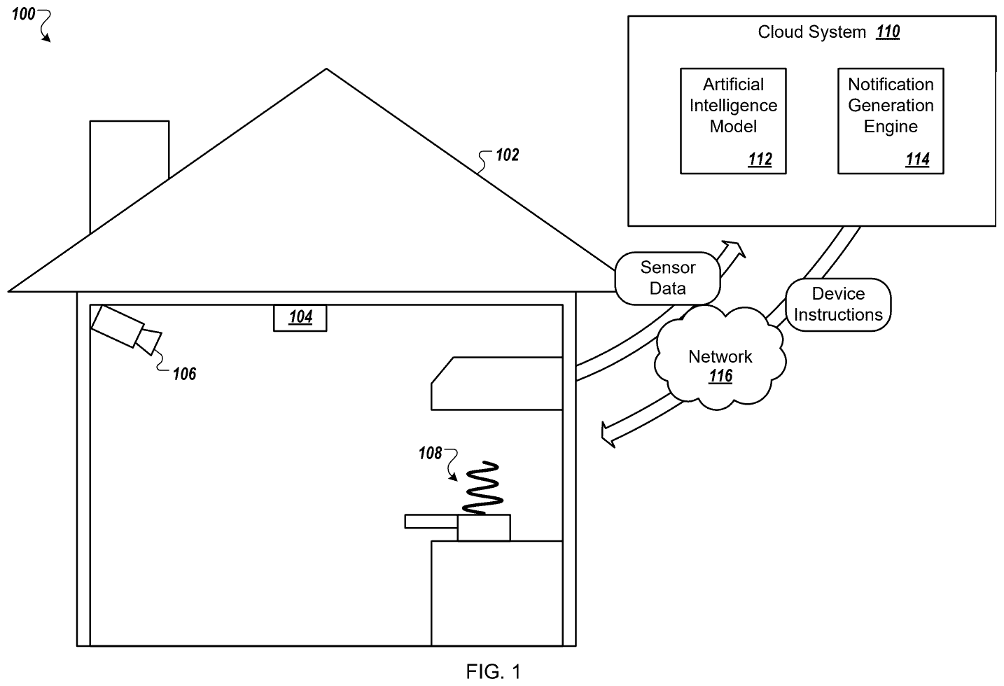

FIG. 1 depicts an example environment 100 for smart sensors. The environment 100 includes a property 102 with two or more sensors 104-106 for detecting an event 108. A cloud system 110 analyzes data from the sensors 104-106, e.g., using an artificial intelligence model 112, to determine whether to trigger an alert given the event 108. Although other sensors, e.g., a dumb smoke detector, would always trigger an alert upon detection of the event 108, e.g., smoke from a stove, the artificial intelligence model 112 determines whether to selectively present an alert given contextual data for the event that is represented in the sensor data.

The event 108 can be any appropriate type of event of interest. For instance, the event 108 can be any type of event for which a dumb sensor would give a binary output value indicating that the event occurred or not. Some examples of events can include detected smoke, fire, water, or motion. In some examples, the event 108 can have an environmental impact on the property 102, e.g., such as a water leak, smoke, or a fire. In some examples, detected motion can have false alarms caused by, e.g., insects, direct sunlight, changing temperatures, improper device sensitivity settings, or people who are allowed to access an area of the property 102 but forgot to disable an alarm. In some instances, a contact sensor can generate a false alarm when the contact sensor batteries are low, was installed incorrectly, or the corresponding window or door was left partially ajar.

The sensors 104-106 can be any appropriate type of sensor. For instance, a first sensor 104 can be a smoke detector and a second sensor 106 can be a camera. In some examples, both sensors 104-106 can be included in a single device, e.g., the smoke detector can include the camera.

At least two of the sensors 104-106 capture sensor data for the same region of the property 102. For example, the smoke detector can be within a threshold distance of a kitchen at the property 102 while the camera is located in and captures images of the kitchen.

A device in the environment 100 uses the captured sensor data to determine whether an event occurred. The device can be any appropriate device, such as the first sensor, a device that includes the first sensor 104, e.g., and optionally the second sensor 106, a control panel for the property 102, a wireless device such as a smart phone for the property 102, or a combination of two or more of these. The device can use first sensor data captured by the first sensor 104, second sensor data captured by the second sensor 106, data that represents some of the sensor data, or a combination of two or more of these, to determine whether the event occurred.

For instance, the smoke detector can use data captured by the first sensor 104 to determine whether an event 108, e.g., smoke from a stove, occurred. In these examples, the smoke detector can use only the first sensor data to make a binary decision regarding whether smoke is detected.

Upon detection of the event 108, the device can trigger capture of sensor data by other sensors 106 at the property 102, retrieval of previously captured sensor data, analysis of captured sensor data, or a combination of these. However, the detection of the event 108 might not immediately trigger presentation of an alert, e.g., at the property 102 or otherwise for the property 102. Instead, the device or a combination of devices for the property 102 will analyze the captured sensor data to determine whether to trigger an alert. By using the artificial intelligence model 112, the cloud system 110 can simulate a smart sensor that makes a more nuanced decision than a binary decision regarding event detection.

The device can instruct one or more other sensors 106 at the property 102 to capture second sensor data, e.g., that will be captured after detection of the event 108. The other sensors 106 can be all sensors or a proper subset of sensors at the property 102. For example, the device can determine the sensors that are within a threshold distance of the event 108 and trigger those determined sensors to capture the second sensor data. The threshold distance can be determined by a unit of measurement, e.g., feet or meters, a number of rooms, or some other appropriate distance. In the example shown in FIG. 1, upon detecting the kitchen smoke, the device can trigger the camera to capture one or more images, e.g., as frames in a video sequence, of the kitchen.

In some examples, the device can access sensor data that was previously captured. The sensor data can be maintained in a database. The database can be at any appropriate location, e.g., at the property 102, in the cloud system 110, or on another device or combination of devices. The previously captured sensor data is sensor data that was captured before the event 108 was detected. For example, the previously captured sensor data can include one or more images of the kitchen that were captured by the camera before the device detected the event 108.

The device can determine previously captured sensor data to access. For instance, the device can use a time period threshold to access previously captured sensor data that was captured at a time that satisfies the time period threshold. This can include accessing previously captured sensor data that was captured, e.g., five minutes before the event 108 was detected. When analysis of the previously captured sensor data, e.g., by the cloud system 110, indicates that the event 108 likely began more than the time period threshold before the event 108 was detected, the device, the cloud system 110, or both, can access additional previously captured sensor data.

The cloud system 110 accesses the second sensor data and data for the detected event. The cloud system 110 can access the second sensor data and the data in any appropriate manner. For instance, when the device that detected the event 108 is a smoke detector, the smoke detector can provide the data for the event to the cloud system. The data for the event can be the first sensor data, data that identifies the detected event, e.g., kitchen smoke, or other appropriate data for the detected event 108.

The cloud system 110 can receive the second sensor data from the second sensors 106, from a database, or a combination of both. For instance, when the second sensors 106 are triggered to capture at least some of the second sensor data, the cloud system 110 can receive at least some of the second sensor data from the second sensors 106. This can include the cloud system 110 receiving the images from the camera. The cloud system 110 can retrieve at least some of the second sensor data from a database, e.g., that maintains previously stored sensor data.

In some implementations, at least some of the second sensors 106 can capture sensor data continuously, e.g., without receiving a trigger to capture sensor data. In these implementations, the database can continually receive second sensor data from these second sensors 106 and store the received second sensor data in memory. The cloud system 110 can access at least some of the stored second sensor data in response to receipt of the data for the event 108, e.g., data that indicates that an event occurred. The cloud system 110, or another device in the environment 100, can cause the second sensors 106 that continually capture sensor data to provide the sensor data to the cloud system 110, e.g., when these sensors were not previously providing the continuously captured sensor data to the cloud system 110.

The cloud system 110 uses the artificial intelligence model 112 to analyze the received data and determine whether to present an alert for the event 108. For instance, although the event 108 was confirmed as having occurred, the artificial intelligence model 112 can determine, using contextual data for the event 108 as represented by the second sensor data, whether a likelihood of the event 108 occurring satisfies an occurrence threshold, whether a risk score satisfies a risk criterion, or a combination of both. When the event 108 is detection of smoke in the kitchen, the smoke might be expected given the type of food being prepared. In some instances, when smoke is detected but a person is already trying to address the issue, e.g., baked food left in the oven too long or food burning on the stove, presenting an alert might cause the situation to worsen.

For instance, a smoke detector might present an alert by emitting a loud, disruptive alarm that requires manual intervention to dismiss while the person is trying to address the issue that caused the smoke. The smoke detect might be in a hard-to-reach place, e.g., on the ceiling, further reducing the person's attention to the issue that caused the smoke. In these situations, the artificial intelligence model 112 can determine to skip presenting an alert. This can result in saved computational resources, e.g., given the lack of transmission of data to a presentation device for an alert; reduced property risk; reduced human resources, e.g., when monitoring or emergency services personnel don't have to respond to the event; or a combination of these.

The artificial intelligence model 112 can use one or more components, e.g., layers, to determine whether to present an alert for the event 108. For example, the artificial intelligence model 112 receives the data for the event 108 and the second senor data as input. In these examples the data for the event can be the first sensor data, data that identifies the detected event, e.g., an event type, or a combination of both. The second sensor data represents contextual data for the detected event 108.

The contextual data can be any appropriate contextual data for the event 108. For instance, the contextual data can represent a number of people within a threshold distance of the event 108, e.g., in the kitchen; ages or age ranges for the people, e.g., whether some of the people are adults or all of the people are children; a degree to which a person is likely aware of the event 108 or a cause of the event, e.g., when the cause of a smoke event is a fire; other situation type specific information; or a combination of two or more of these. Some examples of situation type specific information can include whether water is accumulating, e.g., from a leak, there is noise that matches a sound signature for a leak, or a combination of both.

In some examples, the components in the artificial intelligence model 112 can compute values that represent the likelihood of the event 108, e.g., given the contextual data, a risk score for the event, or both. Although these values might not explicitly be output by the artificial intelligence model 112 during runtime, these values might be used during training, only internally by the artificial intelligence model 112, e.g., and represented as values passed between various components in the model, or a combination of both. These values can indicate a degree to which the event 108 is reasonable, expected, or both, given the contextual information. For instance, the values can indicate whether smoke is expected given the food being prepared in the kitchen. This can indicate a likelihood of the event 108, e.g., smoke, occurring. In some instances, these values can indicate a degree to which the event 108 represents a risk, e.g., to a person, the property 102, or both. For example, when the event 108 is smoke, the values can indicate whether the smoke presents a risk such as smoke damage to the property, a person, or both. The components can analyze the values, e.g., using an activation function, to determine whether the likelihood satisfies an occurrence threshold, e.g., is likely to happen, a risk threshold, or a combination of both.

The artificial intelligence model 112 can use a result of whether a value, e.g., risk score, satisfies the corresponding threshold when determining whether to perform an action, the action to perform, or a combination of both. For instance, some actions can be conditional on whether the risk threshold is satisfied.

The cloud system 110 receives, from the artificial intelligence model 112, output that indicates whether to perform an action for the event. The action can include providing a notification, e.g., an alarm or other type of notification, about the event 108. The output can be any appropriate type of value or values. For instance, the output can be a single value that indicates whether to perform an action for the event 108. When the action is providing a notification about the event, zero can indicate that no notification should be provided and one can indicate that a notification should be provided.

The output can indicate one or more values computed by the artificial intelligence model 112 when analyzing the event. For instance, the output can indicate the likelihood of the event, the risk score for the event, or a combination of both.

In some examples, the output indicates whether an event occurred, e.g., irrespective of whether an action should be performed for the event. For instance, the output can include a first value that indicates whether a notification about the event 108 should be provided and a second value that indicates whether an event of interest actually occurred. In the example of the detected smoke above, the output can indicate that a smoke event was detected even though the artificial intelligence model 112 might determine that no action should be performed for the smoke event. In these examples, the output can include two values. The first value can indicate whether an event of interest likely occurred and the second value can indicate whether an action should be performed for the event. When the first value is false, indicating that an event of interest did not likely occur, the second value can be false. When the first value is true, the second value can be either true or false, depending on whether a notification should be presented.

In some implementations, the output can indicate a type of action to perform. The type of action can include a type of notification, an automated action, e.g., for a device at or otherwise related to the property 102, or a combination of both. In the detected smoke event 108 example, the action can include causing a device at the property 102 to output water, turn off electricity, provide access to an entrance for emergency services, or a combination of these. Provision of access to an entrance can include unlocking a door, opening a door, maintaining a door in an open position, another appropriate action, or a combination of these.

The artificial intelligence model 112 can determine the type of notification given the contextual data. For instance, when the second sensor data indicates that no people are in the kitchen, the notification type can be a smoke detected type. The notification can be a smoke detector sound, an audible notification that indicates the area in which smoke was detected, e.g., the kitchen or a bedroom; a visual notification; a procedurally generated notification; another appropriate notification; or any combination of these. The cloud system, or a device or system at the property 102, can select the presentation device using sensor data from the property, e.g., that indicates presence of a person, an adult, or both, in a room at the property. The sensor data can include camera data. The selected presentation device can be any appropriate device that has the corresponding presentation type, e.g., a camera, a speaker, or a television. When the second sensor data indicates that at least one person is in the kitchen, e.g., and that person is likely an adult, the notification type can be a prompt or other information for that at least one person. Notifications that are not procedurally generated, can be notifications that are selected from multiple predetermined alerts.

The cloud system 110 can use a notification generation engine 114 to generate a notification for the event 108. For instance, the notification generation engine 114 can use the output of the artificial intelligence model 112 to generate the notification, e.g., given the notification type or other data in the output. The notification can include information about how to mitigate the event 108. When at least one person is in the kitchen, the notification generation engine 114 can generate a notification prompting whether the person is aware of the smoke, indicating one or more steps to mitigate the smoke, or a combination of both.

For instance, the notification generation engine 114 can generate a first notification prompting for input indicating whether the person is aware of the smoke event 108. The cloud system 110 can provide, to a device, instructions for presentation of the notification by the device, e.g., a speaker, for the property 102. Upon receipt of input indicating that the person is unaware of the event 108, the cloud system 110 can cause the device to present a notification that indicates where the event occurred, e.g., and is potentially still occurring. The notification generation engine 114 can determine one or more steps to mitigate the event and generate a second notification that indicates those one or more steps. The cloud system 110 sends instructions to the device to cause the device to present the second notification. The device can then present the second notification, e.g., indicating that “the fire should be doused with flour”.

In some examples, the notification generation engine 114 generates a notification specific to a type of person being notified. For example, although a notification for an adult might indicate how to douse a fire, the notification generation engine 114 can generate a notification for a child that indicates that the child should “please turn the stove off and back away from the stove.”

The notification generation engine 114 can generate customized notifications for specific people. For instance, the notification generation engine can be a learning model that learns how a person associated with, e.g., at or otherwise for, the property 102 reacts to an event, or certain types of events, and uses that learned information when generating a notification for the person. When the notification generation engine 114 determines that a person doesn't know what to do for a particular type of event, or events generally, the notification generation engine 114 can always generate a notification for the person that indicates how to address the event. In some examples, when the notification generation engine 114 learns that a particular person defaults to getting water for a stove fire, the notification generation engine 114 can generate a first message that instructs the person to “don't use water on the fire-use flour instead”, e.g., instead of prompting whether the person is aware of the smoke.

By using the contextual data to determine whether to present a notification for the event, rather than making a binary decision regarding detection of the event and then presenting a notification, the environment 100 enables a range of actions that can be performed in response to detection of an event. For instance, even when the event 108 is detected, the cloud system 110 can determine to skip presenting a notification, e.g., upon determining that a person is already addressing the event 108, such as smoke.

In some examples, the cloud system 110, e.g., the notification generation engine 114, can determine devices for the property 102 that should present the notification. The devices can be any appropriate type of devices for the property 102, such as devices physically at the property 102, a mobile device of a person associated with the property 102, a device at a central station, a device that is part of a remote monitoring system, or any combination of these. For instance, the cloud system 110 can use contextual data for the property 102 to determine a proper subset of notification devices for the property 102 that should present a notification. As a result, instead of presenting a smoke alert on all smoke alarms at the property 102, the environment 100 can present a smoke alert on only a proper subset of the smoke alarms. This can occur when a water leak is detected in the kitchen and someone is taking a nap in the living room. Depending on the severity of the water leak, e.g., if the leak is small, the cloud system 110 can determine to present a notification on only a presentation device in a bedroom, e.g., to reduce a likelihood of waking the person taking a nap. This notification device can be a device in an adult's bedroom, an adult's smart phone, or a combination of both. By presenting the targeted notification on a proper subset of devices, the environment 100 can reduce computational resource usage, reduce an impact of an alert on people who are less likely to be able to address the event 108, or a combination of both.

The notification can have any appropriate presentation type. For instance, the notification can be presented visually, audibly, or a combination of both.

The artificial intelligence model 112 can be any appropriate type of model. For instance, the artificial intelligence model 112 can be a large language model. In some examples, the notification generation engine 114 is part of the artificial intelligence model 112.

The cloud system 110 is an example of a system implemented as computer programs on one or more computers in one or more locations, in which the systems, components, and techniques described in this specification are implemented. A network 116, such as a local area network (“LAN”), wide area network (“WAN”), the Internet, or a combination thereof, connects the sensors 104-106, and the cloud system 110. In some examples, the cloud system 110 can be part of, e.g., implemented on, a monitoring system included at the property 102, e.g., and that includes the sensors 104-106. In some instances, the cloud system 110 can be implemented on a sensor, e.g., a smoke detector, or another device at the property 102. In these instances, the cloud system can be implemented as a local system instead of a cloud system. The cloud system 110 can use a single computer or multiple computers operating in conjunction with one another, including, for example, a set of remote computers deployed as a cloud computing service.

The cloud system 110 can include several different functional components, including the artificial intelligence model 112, and the notification generation engine 114. The artificial intelligence model 112, the notification generation engine 114 or a combination of these, can include one or more data processing apparatuses, can be implemented in code, or a combination of both. For instance, each of the artificial intelligence model 112 and the notification generation engine 114 can include one or more data processors and instructions that cause the one or more data processors to perform the operations discussed herein.

The various functional components of the cloud system 110 can be installed on one or more computers as separate functional components or as different modules of a same functional component. For example, the components of the cloud system 110 can be implemented as computer programs installed on one or more computers in one or more locations that are coupled to each through a network. In cloud-based systems for example, these components can be implemented by individual computing nodes of a distributed computing system.

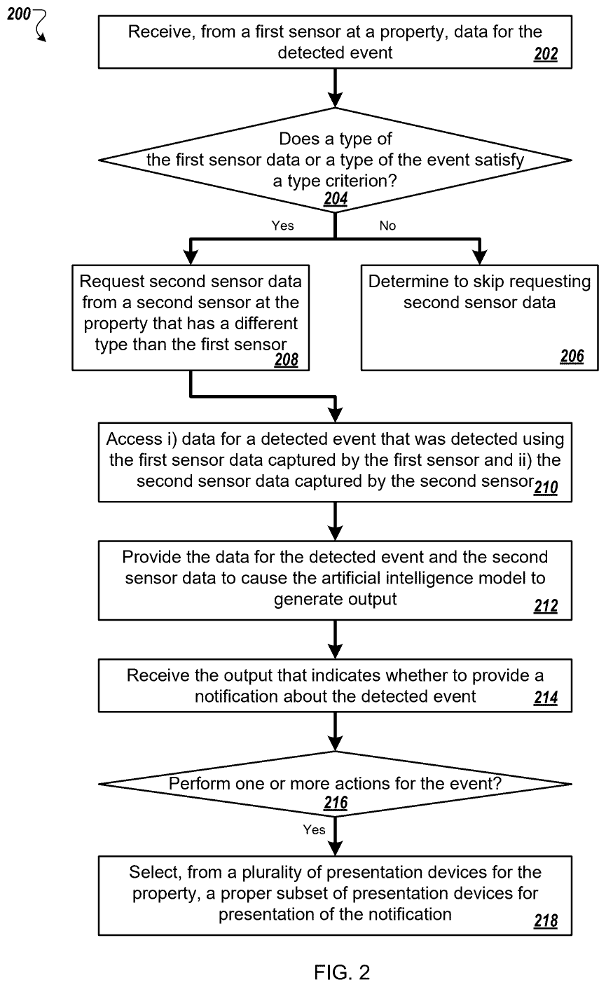

FIG. 2 is a flow diagram of a process 200 for determining whether to perform an action for an event. For example, the process 200 can be used by the cloud system 110, e.g., the artificial intelligence model 112, from the environment 100.

A cloud system receives, from a first sensor at a property, data for the detected event (202). The data can be any appropriate data. The data can be data that triggered detection of the event, e.g., motion data, video data, smoke detector data, e.g., photoelectric or ionization data, audio data, other appropriate types of data, or a combination of two or more of these.

In some examples, the data can be an event notification. For example, instead of included the sensor data itself, the data can indicate that an event occurred, e.g., smoke or a water leak were detected.

The cloud system determines whether a type of the first sensor data or a type of the event satisfies a type criterion (204). For instance, the cloud system can use the sensor data type, the event type, or both, to determine what types of analysis should be performed for the detected event.

The cloud system determines to skip requesting second sensor data (206). In response to determining that the type criterion, or multiple type criteria, are not satisfied, the cloud system can determine to skip requesting second, e.g., additional, sensor data. The second sensor data is sensor data that, at least in part, was captured by a different sensor at the property than the first sensor. When the smoke detector detects a smoke event, the second sensor can be a camera. When a water sensor detects a water leak event, the second sensor can be a camera, a microphone, a motion sensor, or a combination of different sensors of these types.

The type criterion can indicate in what instances the cloud system should make more nuanced decisions, e.g., not binary, when determining whether to present a notification. In some instances, there might be a need for a binary notification. As a result, the cloud system can use the type criterion to determine whether only a binary decision needs to be made regarding notification presentation.

In some instances, the cloud system can make a binary decision and a more nuanced decision, e.g., perform both operations 206 and 208. For example, when a person is injured, the cloud system can determine to both alert medical responders, e.g., first responders, and a person associated with the property, e.g., a parent or a property manager. In instances in which the cloud system determines to only alert one entity, e.g., medical responders, the injured person might not be associated with the property, e.g., is a stranger who was hurt, when no one is at the property, e.g., the residents are on vacation or the injury occurred outside business hours when the property was vacant. In these instances, the cloud system might still perform one or more of operations 208 through 216, while determining to skip presenting a customized notification for the event since no one is at the property, which notification would have been presented if someone were at the property.

The cloud system requests second sensor data from a second sensor at the property that has a different type than the first sensor (208). In response to determining that the type criterion is satisfied, the cloud system can request the second sensor data. The second sensor data can be any appropriate type of sensor data that has a different type than the sensor data captured by the first sensor that detected the event. The second sensor data can be data captured after the event was detected, substantially concurrently with event detection, or prior to event detection. When captured prior to event detection, the second sensor data can be selected as having been captured within a threshold time period of the event detection.

The cloud system accesses i) data for a detected event that was detected using the first sensor data captured by the first sensor and ii) the second sensor data captured by the second sensor (210). For instance, the cloud system can receive the second data. When the cloud system previously received the data for the detected event, the cloud system can retrieve the data from memory in which the data was stored.

The cloud system provides the data for the detected event and the second sensor data to cause the artificial intelligence model to generate output (212). The cloud system can provide the data and the second sensor data as input to the artificial intelligence model. The cloud system can provide any other appropriate data as input to the artificial intelligence model.

The cloud system receives the output that indicates whether to provide a notification about the detected event (214). In some examples, in response to providing the input to the artificial intelligence model, the cloud system can receive the output. The output can be any appropriate type of value or values. For instance, as described in more detail above, the output can indicate a notification type, devices or accounts to which a notification should be provided, whether an action should be performed, a type of action to perform, or a combination of these.

The cloud system determines whether to perform one or more actions for the event (216). For instance, the cloud system uses the output from the artificial intelligence model to determine whether to perform one or more actions. The actions can be any appropriate actions. For example, the actions can be actions that would have been performed if only a binary decision was made to trigger an alert given detection of the event. However, at least in some instances, the cloud system can determine to skip performing an action, e.g., when smoke is detected in a kitchen and someone is already addressing the cause of the smoke. In some implementations, the action can be an action that would not necessarily have been performed by the system, for the person, or both. For instance, the cloud system can determine an action that projects light on an area, e.g., to help a person see something such as to find an object, indicate the location of a fuse box or other power source for disabling power to prevent an electrical fire, activates a sprinkler system, changes a lock state for an entrance, or a combination of two or more of these. The object can be an object that the person forgot where they placed it, that is in a less familiar environment, e.g., a fire extinguisher at a rental unit, or another appropriate object.

In some instances, the action can be alerting someone not associated with the property. For example, the cloud system can determine to alert an emergency responder. The cloud system can provide data, to an emergency responder device, that identifies the event, what is happening at the property, other appropriate data, or a combination of these.

The action can include an action for a smart device at the property. For instance, the cloud system can generate instructions for a device at the property that cause the device to perform the action. The action can be an action to mitigate a likely impact of the event, e.g., damage caused by the event, such as shutting a water valve, or turning the device or a component of the device off. The latter can include causing a stove to turn off a burner included in the stove.

The cloud system selects, from a plurality of presentation devices for the property, a proper subset of presentation devices for presentation of the notification (218). The cloud system can select the proper subset of devices using the output from the artificial intelligence model. The cloud system can select the proper subset of devices using a notification type, e.g., when the notification is for presentation on an application executing on a device, the cloud system can provide the notification to the devices that execute that application. The device can be a smart phone or a tablet that is executing the application. When the property only has one device executing the application for the property, the cloud system can select that device. When the event is detected smoke, the cloud system can select all smoke detectors at the property or fewer than all smoke detectors, e.g., in instances when there are unoccupied rooms, a sleeping child in a room who shouldn't be awoken because of minor smoke from baking, or a combination of these. In some instances, the cloud system selects the presentation devices when the output does not identify the presentation devices.

The order of operations in the process 200 described above is illustrative only, and determining whether to perform an action for the event can be performed in different orders. For example, the process 200 can access previously stored data, e.g., perform at least part of operation 210, before or substantially concurrently with, operation 208.

In some implementations, the process 200 can include additional operations, fewer operations, or some of the operations can be divided into multiple operations. For example, the process 200 can include operations 202, 208, 212, and 214, e.g., in addition to performing an action. The process 200 can include operations 210, 212, 214, e.g., in addition to performing an action.

In some implementations, instead of determining to skip requesting the second senor data, the process 200 can include, as operation 206, performing a default action given detection of the event. The default action can be the action that would be performed when a binary decision is made regarding whether or not an event is detected. In some examples, the process 200 can include operations 204, performing the default action, 208, 212, and 214, e.g., when the process 200 determines that although the event criterion is satisfied, the default action should be performed. This can occur given the type of the event, the severity of the event, or a combination of both.

In some implementations, at least part of the process 200 can be part of a conversational interaction. For instance, a conversational agent, e.g., executing at least in part on a user device, can receive input from and provide data, e.g., notifications to, a user. The conversational agent might receive data from the cloud system that can be used as part of the conversation with the user. When the system detects an event and determines to present a notification for the event, the system can provide data for the notification to the conversational agent. The conversational agent can then present one of multiple messages, e.g., notifications, to the user. For example, the conversational agent can prompt the user with “are you cooking with oil?” When the conversational agent receives input indicating a “yes” response, the conversational agent can indicate that a cooking fire should be put out with flour or a fire extinguisher and not water.

In some implementations, at least part of the process 200 can use contextual data for an event. For instance, upon detecting the event, a system can access sensor data captured by other sensors within a threshold period of time prior to event detection. For smoke in a kitchen, this sensor data can include images captured by a camera for the threshold time period prior to detection of the smoke. The system can analyze the images to determine the contextual data for the event, e.g., whether a person added oil to a pan before the smoke began. The system, e.g., the artificial intelligence model, can then use the contextual data when generating a notification. For example, the system might be less likely to generate a notification for detected smoke when oil was added to the pan than if oil was not added to the pan, given that oil can be a cause of smoke.

In some instances, the system can use the type of a detected object, e.g., oil, when determining whether to present a notification. For example, since some types of oil are more likely to cause smoke than others, the system can be less likely to generate a notification when those smoky types of oil are added to the pan than a different, less smoky oil type.

The system can use the contextual data to determine how to present a notification. For instance, when smoky oil was added to a pan and the system receives data indicating a smoke event was detected, the system can determine to present a notification to a person in the kitchen rather than a property-wide notification that smoke was detected.

In some implementations, the system can use an event type to select one or more sensor data types for use determining whether to present a notification. For instance, upon detecting smoke, the system can determine to analyze camera data. Upon detecting a glass break sound event, the system can determine to analyze camera data and motion data.

In some implementations, the system can determine to trigger one or more actions given an event type, a risk score, or both. For instance, if a risk score indicates that the event type is critical, e.g., a person was injured, the system can determine to perform one or more actions, e.g., to alert emergency personnel such as first responders, while analyzing the data to determine other actions to perform.

Operations described in this specification that include analysis can be performed by the artificial intelligence model as part of inference. For instance, the artificial intelligence model can receive, as input, first data for the first sensor data and second data for the second sensor data. The first data, the second data, or both, can be vectors.

In some implementations, the artificial intelligence model can receive a prompt, separate from the sensor data, as input. These implementations can include use of the first sensor data, e.g., optionally without the second sensor data that represents the contextual data for the event.

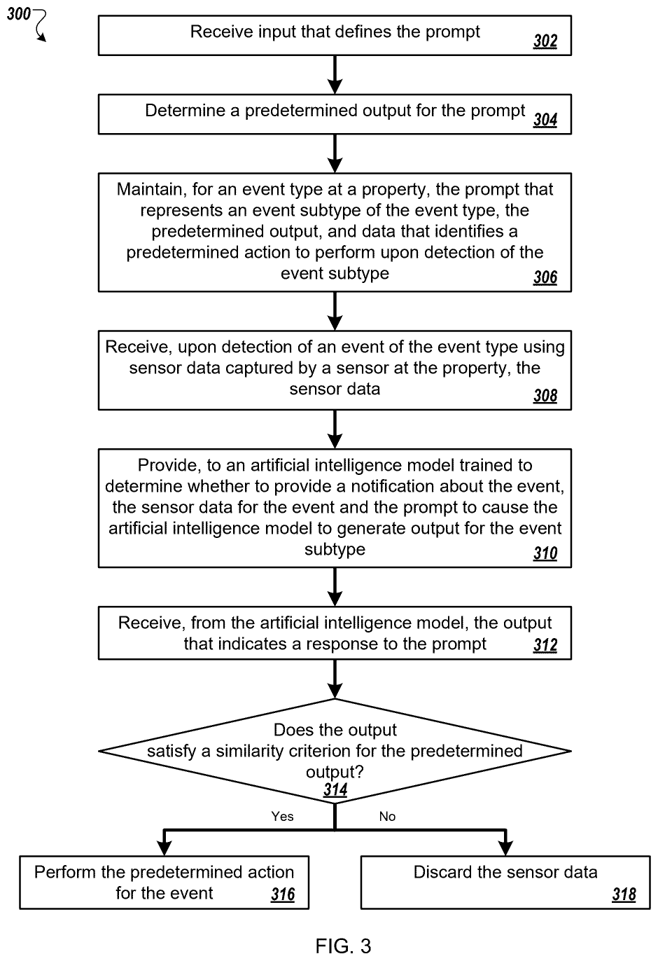

FIG. 3 is a flow diagram of a process 300 for determining whether to perform an action for an event using a prompt. For example, the process 300 can be used by the cloud system 110 from the environment 100.

A cloud system receives input that defines the prompt (302). For instance, the cloud system can receive the input from a user device executing a home security application. The home security application can receive the input, e.g., as typed or voice input. The cloud system can receive the input via a network. The prompt defines an event subtype for an event.

For instance, when an event is “person detected,” the prompt can indicate “is the person wearing a hard hat.” Instead of triggering an alert each time the event is detected, a monitoring system can trigger one or more particular actions only when the event subtype is detected, e.g., person not wearing a hard hat, instead of each time the event itself is detected.

Event detection can occur at another device or system. For instance, during runtime, a sensor can use a model to detect the event. The model can be less robust, smaller, use fewer computational resources, or a combination of these, compared to an artificial intelligence model used by the cloud system. As a result, the cloud system receives sensor data from the other device only upon detection of the event, e.g., and not for all sensor data. This can reduce network resource usage that would otherwise be required to transmit all sensor data from the device to the cloud system, power used by the device for such data transmission, or a combination of both.

In the above example, the input can be received from a device of a construction employee. The device can be a device, e.g., a camera, at a corresponding construction site. The event subtype can be used to increase a likelihood that workers at the construction site are wearing proper safety equipment.

The cloud system determines a predetermined output for the prompt (304). For example, the cloud system can receive the predetermined output that was input on a device, e.g., the user device from which the cloud system receives the prompt. In some instances, the cloud system can predict the predetermined output given the input.

The prompt can have an output value type that is one of multiple output value types. Some examples of output value types include Boolean, numeric, enumerated, and descriptive. The output type can be used to restrict the types of output values generated by the cloud system's artificial intelligence model. For instance, the cloud system can use the output types during runtime, training, or both, to restrict the types of outputs generated by the artificial intelligence model.

The prompt can have a response structure. For instance, the cloud system can select a response structure given the output value type, other appropriate data, or both.

When the cloud system does not receive the predetermined output, the cloud system can predict the predetermined output, e.g., using a predicted output type for the prompt. For instance, given the prompt of “is the person wearing a hard hat,” the cloud system can predict an output value of yes or no, e.g., for a Boolean output type.

The cloud system maintains, for the prompt, data that indicates one or more actions to perform, e.g., predetermined actions. For instance, when the predetermined output is “no” the person depicted in an image is not wearing a hard hat, the action can include providing a notification or another alert about the person not wearing a hard hat. This can include presenting, using a speaker in an area within a threshold distance of the person, a request that the person put on a hard hat.

In some examples, the cloud system receives input indicating the actions to perform. For instance, the input that indicates the prompt, the predetermined output, or both, can indicate the one or more actions to perform. In some instances, the cloud system can predict the predetermined output using a combination of the prompt and the one or more actions, e.g., when the input does not identify the predetermined output.

A prompt with an enumerated output type can have an output that is one of a predetermined list of options. An example of an enumerated prompt includes “what type of vehicle is depicted?” for instance indicating an event subtype trigger for depiction of a vehicle in a driveway. Some examples of the enumerated outputs can include SUV, truck, car, or semi. In these examples, an action can be performed when particular types of the enumerated value, e.g., car or truck, are detected in the sensor data.

One example of a prompt with a numeric output type is the prompt “how many trash cans are visible?” The predetermined output can indicate that at least two trash cans must be visible. In this example, the prompt can include a day of week, time, or both. For instance, the prompt can be “how many trash cans are visible on Thursday at 4 pm?”. This can indicate a prompt for a business to increase a likelihood that all trash cans are placed in the proper pickup location, e.g., at the curb, by the end of Thursday's business day for a Friday pickup. In these examples, an action can be performed, e.g., presentation of a notification, if fewer than two trash cans are visible on Thursday at 4 pm.

The cloud system maintains, for an event type at a property, the prompt that represents an event subtype of the event type, the predetermined output, and data that identifies a predetermined action to perform upon detection of the event subtype (306). For instance, the cloud system can include a database of records each of which indicate a corresponding prompt, predetermined output, and predetermined action.

The cloud system receives, upon detection of an event of the event type using sensor data captured by a sensor at the property, the sensor data (308). For example, a camera can capture one or more images at a property. The camera can determine whether an event of the event type is detected in the captured sensor data, e.g., images. If not, the camera can determine to skip transmitting the captured sensor data to the cloud system. In these instances, the camera can delete the sensor data. If the event of the event type is detected in the sensor data, the camera can transmit the sensor data to the cloud system. The cloud system receives the transmitted sensor data.

The cloud system accesses the event type for the event. For instance, the cloud system can receive data from the device that indicates the event type. In some examples, the cloud system can analyze the received sensor data to determine the event type.

The cloud system uses the event type to determine one or more subtypes for the event type. For example, the cloud system can determine the records that have a subtype of the corresponding event type. The cloud system can access the records for those subtypes to determine prompts for the artificial intelligence model. For instance, the cloud system can determine, for one of the event subtypes, the corresponding prompt. The cloud system can perform one or more of operations 310 to 318 for at least some, e.g., each, of the determined subtypes.

The cloud system provides, to an artificial intelligence model trained to determine whether to provide a notification about the event, the sensor data for the event and the prompt to cause the artificial intelligence model to generate output for the event subtype (310). For example, the cloud system can generate representations of the sensor data for the event to the artificial intelligence model. The representations can be any appropriate type of representations, e.g., vectors. The cloud system can maintain, in memory, a representation of the prompt. The prompt representation can be generated in advance, e.g., stored in the record for the event subtype, or in response to receipt of the sensor data. In some instances, the received sensor data can be a vector. In some implementations, the cloud system can generate the sensor data vector in response to receipt of the sensor data.

In some examples, the cloud system can provide, as input to the artificial intelligence model, the output type for the prompt. For example, given the prompt “is the person wearing a hard hat?”, the cloud system can provide the type “Boolean” as input.

The cloud system receives, from the artificial intelligence model, the output that indicates a response to the prompt (312). For instance, the cloud system receives a vector as the output from the artificial intelligence model. The output can have the output type associated with the prompt. For instance, for the prompt “is the person wearing a hard hat”, the cloud system can receive output, e.g., as a vector, that has a Boolean value. Although the output is a Boolean value, the cloud system receives a vector to enable the cloud system to receive different types of output for different prompts.

The cloud system determines whether the output satisfies a similarity criterion for the predetermined output and to perform the predetermined action for the event (314). The similarity criterion can be any appropriate type of criterion. For instance, the criterion can be an exact match, e.g., for a Boolean output value; a range, e.g., for a numerical value and that indicates whether the output satisfies a numerical range defined by the predetermined output; or a string similarity criterion. For a string similarity criterion, the criterion can allow for minor variations, e.g., when the predetermined output indicates vehicle and the output indicates car, the cloud system can determine that the string similarity criterion is satisfied. For a numerical range, when the output number falls within the predetermined range or outside the range, depending on the requirements for the event subtype, the cloud system can determine that the predetermined numerical range is satisfied. As a result of the above, the predetermined output can be used to define, at least in part, the similarity criterion for the prompt.

In some examples, the cloud system can determine whether the output is of a required output type for the prompt. If so, the cloud system can determine whether the output satisfies the similarity criterion. If not, the cloud system can determine to perform the predetermined action, another action, e.g., to output an error, or to not perform any further action for the detected event.

The cloud system performs the predetermined action for the event (316). For instance, in response to determining that the output satisfies the similarity criterion for the predetermined output, the cloud system performs the predetermined action. The predetermined action can be any appropriate type of action, such as sending instructions for presentation of a notification on a device, e.g., indicating that a person is not wearing a hard hat. In some examples, the predetermined action can include sending instructions to a device at other otherwise for the property to cause the device to perform an action, e.g., adding data for the event in a log, presenting an audible message, opening a garage door, unlocking a door, or a combination of these.

The output can satisfy the similarity criterion for the predetermined output in any appropriate way. Given the combination of the prompt and the predetermined output, the similarity criterion can require a match, a value that falls within a range, not a match, or some other appropriate value. For instance, when the prompt is “is the person wearing a hard hat,” the similarity criterion can be satisfied when the output is “no” which does not match the predetermined output of “yes.” When the prompt is “is the person not wearing a hard hat” and the predetermined output is “yes,” the cloud system can determine that the similarity criterion is satisfied when the output from the artificial intelligence model is “yes”.

The cloud system discards the sensor data (318). For instance, in response to determining that the output does not satisfy the similarity criterion for the predetermined output, the cloud system can discard the sensor data. This can include the cloud system determining to not take any further action for the detected event.

In some implementations, the process 300 can include additional operations, fewer operations, or some of the operations can be divided into multiple operations. For example, the process 300 can include operations 306, 310, 312, 314, and 316 without the other operations in the process 300. In some examples, the process 300 can include operations 306, 310, 312, 314, and 318 without the other operations in the process 300. In some instances, the process 300 can optionally include operations 302 and 304, e.g., in any of the above-mentioned combinations of operations. The process 300 can optionally include operation 308.

The artificial intelligence model used in the process 300 can be trained in any appropriate manner. For instance, the artificial intelligence model can be trained using sensor data to text associations, e.g., image text associations. As a result, the artificial intelligence model can detect specific types of features in sensor data, such as whether a person is wearing a hard hat, and generate a wider variety of output than the model used to detect the event, e.g., that executes on the sensor or another device.

For situations in which the systems discussed here collect personal information about people, or may make use of personal information, the people may be provided with an opportunity to control whether programs or features collect personal information (e.g., information about a person's activities, a person's preferences, or a person's current location), or to control whether and/or how the system operates. In addition, certain data may be anonymized in one or more ways before it is stored or used, so that personally identifiable information is removed. For example, a person's identity may be anonymized so that no personally identifiable information can be determined for the person. Thus, the person may have control over how information is collected about them and used.

In this specification, the term “database” is used broadly to refer to any collection of data: the data does not need to be structured in any particular way, or structured at all, and it can be stored on storage devices in one or more locations. A database can be implemented on any appropriate type of memory.

In this specification the term “engine” is used broadly to refer to a software-based system, subsystem, or process that is programmed to perform one or more specific functions. One example of an engine can include a model. Generally, an engine will be implemented as one or more software modules or components, installed on one or more computers in one or more locations. In some instances, one or more computers will be dedicated to a particular engine. In some instances, multiple engines can be installed and running on the same computer or computers.

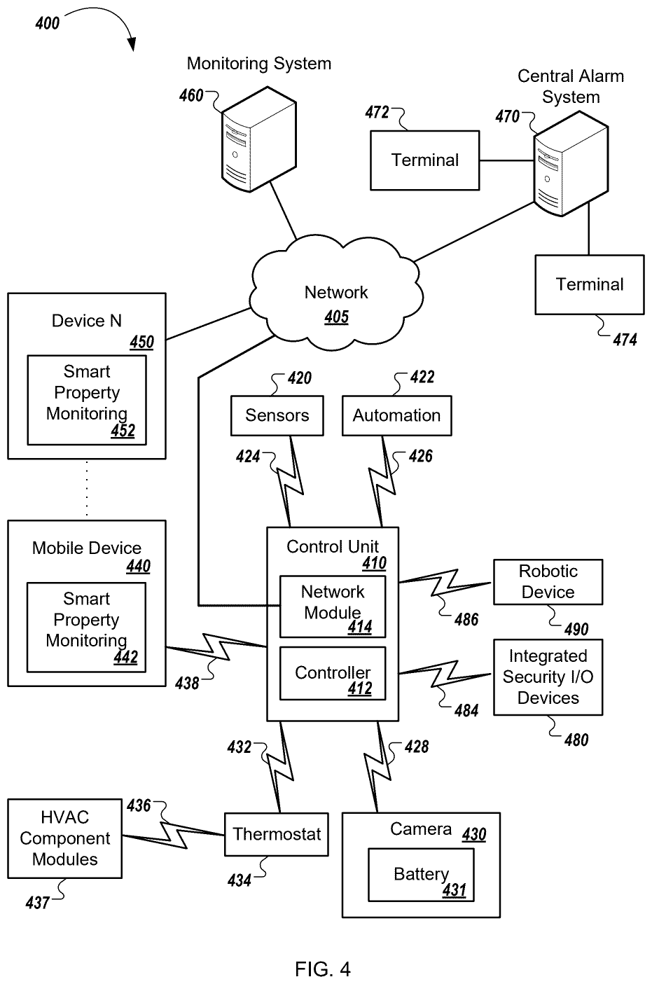

FIG. 4 is a diagram illustrating an example of an environment 400, e.g., for monitoring a property. The property can be any appropriate type of property, such as a home, a business, or a combination of both. The environment 400 includes a network 405, a control unit 410, one or more devices 440 and 450, a monitoring system 460, a central alarm system 470, or a combination of two or more of these. In some examples, the network 405 facilitates communications between two or more of the control unit 410, the one or more devices 440 and 450, the monitoring system 460, and the central alarm system 470.

The network 405 is configured to enable exchange of electronic communications between devices connected to the network 405. For example, the network 405 can be configured to enable exchange of electronic communications between the control unit 410, the one or more devices 440 and 450, the monitoring system 460, and the central alarm system 470. The network 405 can include, for example, one or more of the Internet, Wide Area Networks (“WANs”), Local Area Networks (“LANs”), analog or digital wired and wireless telephone networks (e.g., a public switched telephone network (“PSTN”), Integrated Services Digital Network (“ISDN”), a cellular network, and Digital Subscriber Line (“DSL”)), radio, television, cable, satellite, any other delivery or tunneling mechanism for carrying data, or a combination of these. The network 405 can include multiple networks or subnetworks, each of which can include, for example, a wired or wireless data pathway. The network 405 can include a circuit-switched network, a packet-switched data network, or any other network able to carry electronic communications (e.g., data or voice communications). For example, the network 405 can include networks based on the Internet protocol (“IP”), asynchronous transfer mode (“ATM”), the PSTN, packet-switched networks based on IP, X.25, or Frame Relay, or other comparable technologies and can support voice using, for example, voice over IP (“VOIP”), or other comparable protocols used for voice communications. The network 405 can include one or more networks that include wireless data channels and wireless voice channels. The network 405 can be a broadband network.

The control unit 410 includes a controller 412 and a network module 414. The controller 412 is configured to control a control unit monitoring system, e.g., a control unit system, that includes the control unit 410. In some examples, the controller 412 can include one or more processors or other control circuitry configured to execute instructions of a program that controls operation of a control unit system. In these examples, the controller 412 can be configured to receive input from sensors, or other devices included in the control unit system and control operations of devices at the property, e.g., speakers, displays, lights, doors, other appropriate devices, or a combination of these. For example, the controller 412 can be configured to control operation of the network module 414 included in the control unit 410.

The network module 414 is a communication device configured to exchange communications over the network 405. The network module 414 can be a wireless communication module configured to exchange wireless, wired, or a combination of both, communications over the network 405. For example, the network module 414 can be a wireless communication device configured to exchange communications over a wireless data channel and a wireless voice channel. In some examples, the network module 414 can transmit alarm data over a wireless data channel and establish a two-way voice communication session over a wireless voice channel. The wireless communication device can include one or more of a LTE module, a GSM module, a radio modem, a cellular transmission module, or any type of module configured to exchange communications in any appropriate type of wireless or wired format.

The network module 414 can be a wired communication module configured to exchange communications over the network 405 using a wired connection. For instance, the network module 414 can be a modem, a network interface card, or another type of network interface device. The network module 414 can be an Ethernet network card configured to enable the control unit 410 to communicate over a local area network, the Internet, or a combination of both. The network module 414 can be a voice band modem configured to enable the alarm panel to communicate over the telephone lines of Plain Old Telephone Systems (“POTS”).

The control unit system that includes the control unit 410 can include one or more sensors 420. For example, the environment 400 can include multiple sensors 420. The sensors 420 can include a lock sensor, a contact sensor, a motion sensor, a camera (e.g., a camera 430), a flow meter, any other type of sensor included in a control unit system, or a combination of two or more of these. The sensors 420 can include an environmental sensor, such as a temperature sensor, a water sensor, a rain sensor, a wind sensor, a light sensor, a smoke detector, a carbon monoxide detector, or an air quality sensor, to name a few additional examples. The sensors 420 can include a health monitoring sensor, such as a prescription bottle sensor that monitors taking of prescriptions, a blood pressure sensor, a blood sugar sensor, or a bed mat configured to sense presence of liquid (e.g., bodily fluids) on the bed mat. In some examples, the health monitoring sensor can be a wearable sensor that attaches to a person, e.g., a user, at the property. The health monitoring sensor can collect various health data, including pulse, heartrate, respiration rate, sugar or glucose level, bodily temperature, motion data, or a combination of these. The sensors 420 can include a radio-frequency identification (“RFID”) sensor that identifies a particular article that includes a pre-assigned RFID tag.

The control unit 410 can communicate with a module 422 and a camera 430 to perform monitoring. The module 422 is connected to one or more devices that enable property automation, e.g., home or business automation. For instance, the module 422 can connect to, and be configured to control operation of, one or more lighting systems. The module 422 can connect to, and be configured to control operation of, one or more electronic locks, e.g., control Z-Wave locks using wireless communications in the Z-Wave protocol. In some examples, the module 422 can connect to, and be configured to control operation of, one or more appliances. The module 422 can include multiple sub-modules that are each specific to a type of device being controlled in an automated manner. The module 422 can control the one or more devices using commands received from the control unit 410. For instance, the module 422 can receive a command from the control unit 410, which command was sent using data captured by the camera 430 that depicts an area. In response, the module 422 can cause a lighting system to illuminate an area to provide better lighting in the area, and a higher likelihood that the camera 430 can capture a subsequent image of the area that depicts more accurate data of the area.

The camera 430 can be an image camera or other type of optical sensing device configured to capture one or more images. For instance, the camera 430 can be configured to capture images of an area within a property monitored by the control unit 410. The camera 430 can be configured to capture single, static images of the area; video of the area, e.g., a sequence of images; or a combination of both. The image captured by the camera can be any appropriate type of image, e.g., a frame. The camera 430 can be controlled using commands received from the control unit 410 or another device in the property monitoring system, e.g., a device 450.

The camera 430 can be triggered using any appropriate techniques, can capture images continuously, or a combination of both. For instance, a Passive Infra-Red (“PIR”) motion sensor can be built into the camera 430 and used to trigger the camera 430 to capture one or more images when motion is detected. The camera 430 can include a microwave motion sensor built into the camera which is used to trigger the camera 430 to capture one or more images when motion is detected. The camera 430 can have a “normally open” or “normally closed” digital input that can trigger capture of one or more images when external sensors detect motion or other events. The external sensors can include another sensor from the sensors 420, PIR, or door or window sensors, to name a few examples. In some implementations, the camera 430 receives a command to capture an image, e.g., when external devices detect motion or another potential alarm event or in response to a request from a device. The camera 430 can receive the command from the controller 412, directly from one of the sensors 420, or a combination of both.

In some examples, the camera 430 triggers integrated or external illuminators to improve image quality when the scene is dark. Some examples of illuminators can include Infra-Red, Z-wave controlled “white” lights, lights controlled by the module 422, or a combination of these. An integrated or separate light sensor can be used to determine if illumination is desired and can result in increased image quality.

The camera 430 can be programmed with any combination of time schedule, day schedule, system “arming state”, other variables, or a combination of these, to determine whether images should be captured when one or more triggers occur. The camera 430 can enter a low-power mode when not capturing images. In this case, the camera 430 can wake periodically to check for inbound messages from the controller 412 or another device. The camera 430 can be powered by internal, replaceable batteries, e.g., if located remotely from the control unit 410. The camera 430 can employ a small solar cell to recharge the battery when light is available. The camera 430 can be powered by a wired power supply, e.g., the controller's 412 power supply if the camera 430 is co-located with the controller 412.

In some implementations, the camera 430 communicates directly with the monitoring system 460 over the network 405. In these implementations, image data captured by the camera 430 need not pass through the control unit 410. The camera 430 can receive commands related to operation from the monitoring system 460, provide images to the monitoring system 460, or a combination of both.

The environment 400 can include one or more thermostats 434, e.g., to perform dynamic environmental control at the property. The thermostat 434 is configured to monitor temperature of the property, energy consumption of a heating, ventilation, and air conditioning (“HVAC”) system associated with the thermostat 434, or both. In some examples, the thermostat 434 is configured to provide control of environmental (e.g., temperature) settings. In some implementations, the thermostat 434 can additionally or alternatively receive data relating to activity at a property; environmental data at a property, e.g., at various locations indoors or outdoors or both at the property; or a combination of both. The thermostat 434 can measure or estimate energy consumption of the HVAC system associated with the thermostat. The thermostat 434 can estimate energy consumption, for example, using data that indicates usage of one or more components of the HVAC system associated with the thermostat 434. The thermostat 434 can communicate various data, e.g., temperature, energy, or both, with the control unit 410. In some examples, the thermostat 434 can control the environment, e.g., temperature, settings in response to commands received from the control unit 410.

In some implementations, the thermostat 434 is a dynamically programmable thermostat and can be integrated with the control unit 410. For example, the dynamically programmable thermostat 434 can include the control unit 410, e.g., as an internal component to the dynamically programmable thermostat 434. In some examples, the control unit 410 can be a gateway device that communicates with the dynamically programmable thermostat 434. In some implementations, the thermostat 434 is controlled via one or more modules 422.

The environment 400 can include the HVAC system or otherwise be connected to the HVAC system. For instance, the environment 400 can include one or more HVAC modules 437. The HVAC modules 437 can be connected to one or more components of the HVAC system associated with a property. A module 437 can be configured to capture sensor data from, control operation of, or both, corresponding components of the HVAC system. In some implementations, the module 437 is configured to monitor energy consumption of an HVAC system component, for example, by directly measuring the energy consumption of the HVAC system components or by estimating the energy usage of the one or more HVAC system components by detecting usage of components of the HVAC system. The module 437 can communicate energy monitoring information, the state of the HVAC system components, or both, to the thermostat 434. The module 437 can control the one or more components of the HVAC system in response to receipt of commands received from the thermostat 434.

In some examples, the environment 400 includes one or more robotic devices 490. The robotic devices 490 can be any type of robots that are capable of moving, such as an aerial drone, a land-based robot, or a combination of both. The robotic devices 490 can take actions, such as capture sensor data or other actions that assist in security monitoring, property automation, or a combination of both. For example, the robotic devices 490 can include robots capable of moving throughout a property using automated navigation control technology, user input control provided by a user, or a combination of both. The robotic devices 490 can fly, roll, walk, or otherwise move about the property. The robotic devices 490 can include helicopter type devices (e.g., quad copters), rolling helicopter type devices (e.g., roller copter devices that can fly and roll along the ground, walls, or ceiling) and land vehicle type devices (e.g., automated cars that drive around a property). In some examples, the robotic devices 490 can be robotic devices 490 that are intended for other purposes and merely associated with the environment 400 for use in appropriate circumstances. For instance, a robotic vacuum cleaner device can be associated with the environment 400 as one of the robotic devices 490 and can be controlled to take action responsive to monitoring system events.

In some examples, the robotic devices 490 automatically navigate within a property. In these examples, the robotic devices 490 include sensors and control processors that guide movement of the robotic devices 490 within the property. For instance, the robotic devices 490 can navigate within the property using one or more cameras, one or more proximity sensors, one or more gyroscopes, one or more accelerometers, one or more magnetometers, a global positioning system (“GPS”) unit, an altimeter, one or more sonar or laser sensors, any other types of sensors that aid in navigation about a space, or a combination of these. The robotic devices 490 can include control processors that process output from the various sensors and control the robotic devices 490 to move along a path that reaches the desired destination, avoids obstacles, or a combination of both. In this regard, the control processors detect walls or other obstacles in the property and guide movement of the robotic devices 490 in a manner that avoids the walls and other obstacles.

In some implementations, the robotic devices 490 can store data that describes attributes of the property. For instance, the robotic devices 490 can store a floorplan, a three-dimensional model of the property, or a combination of both, that enable the robotic devices 490 to navigate the property. During initial configuration, the robotic devices 490 can receive the data describing attributes of the property, determine a frame of reference to the data (e.g., a property or reference location in the property), and navigate the property using the frame of reference and the data describing attributes of the property. In some examples, initial configuration of the robotic devices 490 can include learning one or more navigation patterns in which a user provides input to control the robotic devices 490 to perform a specific navigation action (e.g., fly to an upstairs bedroom and spin around while capturing video and then return to a property charging base). In this regard, the robotic devices 490 can learn and store the navigation patterns such that the robotic devices 490 can automatically repeat the specific navigation actions upon a later request.

In some examples, the robotic devices 490 can include data capture devices. In these examples, the robotic devices 490 can include, as data capture devices, one or more cameras, one or more motion sensors, one or more microphones, one or more biometric data collection tools, one or more temperature sensors, one or more humidity sensors, one or more air flow sensors, any other type of sensor that can be useful in capturing monitoring data related to the property and users in the property, or a combination of these. The one or more biometric data collection tools can be configured to collect biometric samples of a person in the property with or without contact of the person. For instance, the biometric data collection tools can include a fingerprint scanner, a hair sample collection tool, a skin cell collection tool, or any other tool that allows the robotic devices 490 to take and store a biometric sample that can be used to identify the person (e.g., a biometric sample with DNA that can be used for DNA testing).

In some implementations, the robotic devices 490 can include output devices. In these implementations, the robotic devices 490 can include one or more displays, one or more speakers, any other type of output devices that allow the robotic devices 490 to communicate information, e.g., to a nearby user or another type of person, or a combination of these.

The robotic devices 490 can include a communication module that enables the robotic devices 490 to communicate with the control unit 410, each other, other devices, or a combination of these. The communication module can be a wireless communication module that allows the robotic devices 490 to communicate wirelessly. For instance, the communication module can be a Wi-Fi module that enables the robotic devices 490 to communicate over a local wireless network at the property. Other types of short-range wireless communication protocols, such as 900 MHz wireless communication, Bluetooth, Bluetooth LE, Z-wave, Zigbee, Matter, or any other appropriate type of wireless communication, can be used to allow the robotic devices 490 to communicate with other devices, e.g., in or off the property. In some implementations, the robotic devices 490 can communicate with each other or with other devices of the environment 400 through the network 405.

The robotic devices 490 can include processor and storage capabilities. The robotic devices 490 can include any one or more suitable processing devices that enable the robotic devices 490 to execute instructions, operate applications, perform the actions described throughout this specification, or a combination of these. In some examples, the robotic devices 490 can include solid-state electronic storage that enables the robotic devices 490 to store applications, configuration data, collected sensor data, any other type of information available to the robotic devices 490, or a combination of two or more of these.

The robotic devices 490 can process captured data locally, provide captured data to one or more other devices for processing, e.g., the control unit 410 or the monitoring system 460, or a combination of both. For instance, the robotic device 490 can provide the images to the control unit 410 for processing. In some examples, the robotic device 490 can process the images to determine an identification of the items.

One or more of the robotic devices 490 can be associated with one or more charging stations. The charging stations can be located at a predefined home base or reference location in the property. The robotic devices 490 can be configured to navigate to one of the charging stations after completion of one or more tasks needed to be performed, e.g., for the environment 400. For instance, after completion of a monitoring operation or upon instruction by the control unit 410, a robotic device 490 can be configured to automatically fly to and connect with, e.g., land on, one of the charging stations. In this regard, a robotic device 490 can automatically recharge one or more batteries included in the robotic device 490 so that the robotic device 490 is less likely to need recharging when the environment 400 requires use of the robotic device 490, e.g., absent other concerns for the robotic device 490.

The charging stations can be contact-based charging stations, wireless charging stations, or a combination of both. For contact-based charging stations, the robotic devices 490 can have readily accessible points of contact to which a robotic device 490 can contact on the charging station. For instance, a helicopter type robotic device can have an electronic contact on a portion of its landing gear that rests on and couples with an electronic pad of a charging station when the helicopter type robotic device lands on the charging station. The electronic contact on the robotic device 490 can include a cover that opens to expose the electronic contact when the robotic device is charging and closes to cover and insulate the electronic contact when the robotic device 490 is in operation.

For wireless charging stations, the robotic devices 490 can charge through a wireless exchange of power. In these instances, a robotic device 490 needs only position itself closely enough to a wireless charging station for the wireless exchange of power to occur. In this regard, the positioning needed to land at a predefined home base or reference location in the property can be less precise than with a contact-based charging station. Based on the robotic devices 490 landing at a wireless charging station, the wireless charging station can output a wireless signal that the robotic device 490 receives and converts to a power signal that charges a battery maintained on the robotic device 490. As described in this specification, a robotic device 490 landing or coupling with a charging station can include a robotic device 490 positioning itself within a threshold distance of a wireless charging station such that the robotic device 490 is able to charge its battery.

In some implementations, one or more of the robotic devices 490 has an assigned charging station. In these implementations, the number of robotic devices 490 can equal the number of charging stations. In these implementations, the robotic devices 490 can always navigate to the specific charging station assigned to that robotic device 490. For instance, a first robotic device can always use a first charging station and a second robotic device can always use a second charging station.

In some examples, the robotic devices 490 can share charging stations. For instance, the robotic devices 490 can use one or more community charging stations that are capable of charging multiple robotic devices 490, e.g., substantially concurrently or separately or a combination of both at different times. The community charging station can be configured to charge multiple robotic devices 490 at substantially the same time, e.g., the community charging station can begin charging a first robotic device and then, while charging the first robotic device, begin charging a second robotic device five minutes later. The community charging station can be configured to charge multiple robotic devices 490 in serial such that the multiple robotic devices 490 take turns charging and, when fully charged, return to a predefined home base or reference location or another location in the property that is not associated with a charging station. The number of community charging stations can be less than the number of robotic devices 490.

In some instances, the charging stations might not be assigned to specific robotic devices 490 and can be capable of charging any of the robotic devices 490. In this regard, the robotic devices 490 can use any suitable, unoccupied charging station when not in use, e.g., when not performing an operation for the environment 400. For instance, when one of the robotic devices 490 has completed an operation or is in need of battery charge, the control unit 410 can reference a stored table of the occupancy status of each charging station and instructs the robotic device to navigate to the nearest charging station that has at least one unoccupied charger.

The environment 400 can include one or more integrated security devices 480. The one or more integrated security devices can include any type of device used to provide alerts based on received sensor data. For instance, the one or more control units 410 can provide one or more alerts to the one or more integrated security input/output devices 480. In some examples, the one or more control units 410 can receive sensor data from the sensors 420 and determine whether to provide an alert, or a message to cause presentation of an alert, to the one or more integrated security input/output devices 480.

The sensors 420, the module 422, the camera 430, the thermostat 434, the module 437, the integrated security devices 480, and the robotic devices 490, can communicate with the controller 412 over communication links 424, 426, 428, 432, 436, 438, 484, and 486. The communication links 424, 426, 428, 432, 436, 438, 484, and 486 can be a wired or wireless data pathway configured to transmit signals between any combination of the sensors 420, the module 422, the camera 430, the thermostat 434, the module 437, the integrated security devices 480, the robotic devices 490, or the controller 412. The sensors 420, the module 422, the camera 430, the thermostat 434, the module 437, the integrated security devices 480, and the robotic devices 490, can continuously transmit sensed values to the controller 412, periodically transmit sensed values to the controller 412, or transmit sensed values to the controller 412 in response to a change in a sensed value, a request, or both. In some implementations, the robotic devices 490 can communicate with the monitoring system 460 over network 405. The robotic devices 490 can connect and communicate with the monitoring system 460 using a Wi-Fi or a cellular connection or any other appropriate type of connection.

The communication links 424, 426, 428, 432, 436, 438, 484, and 486 can include any appropriate type of network, such as a local network. The sensors 420, the module 422, the camera 430, the thermostat 434, the robotic devices 490 and the integrated security devices 480, and the controller 412 can exchange data and commands over the network.

The monitoring system 460 can include one or more electronic devices, e.g., one or more computers. The monitoring system 460 is configured to provide monitoring services by exchanging electronic communications with the control unit 410, the one or more devices 440 and 450, the central alarm system 470, or a combination of these, over the network 405. For example, the monitoring system 460 can be configured to monitor events (e.g., alarm events) generated by the control unit 410. In these examples, the monitoring system 460 can exchange electronic communications with the network module 414 included in the control unit 410 to receive information regarding events (e.g., alerts) detected by the control unit 410. The monitoring system 460 can receive information regarding events (e.g., alerts) from the one or more devices 440 and 450.

In some implementations, the monitoring system 460 might be configured to provide one or more services other than monitoring services. In these implementations, the monitoring system 460 might perform one or more operations described in this specification without providing any monitoring services, e.g., the monitoring system 460 might not be a monitoring system as described in the example shown in FIG. 4.

In some examples, the monitoring system 460 can route alert data received from the network module 414 or the one or more devices 440 and 450 to the central alarm system 470. For example, the monitoring system 460 can transmit the alert data to the central alarm system 470 over the network 405.

The monitoring system 460 can store sensor and image data received from the environment 400 and perform analysis of sensor and image data received from the environment 400. Based on the analysis, the monitoring system 460 can communicate with and control aspects of the control unit 410 or the one or more devices 440 and 450.

The monitoring system 460 can provide various monitoring services to the environment 400. For example, the monitoring system 460 can analyze the sensor, image, and other data to determine an activity pattern of a person of the property monitored by the environment 400. In some implementations, the monitoring system 460 can analyze the data for alarm conditions or can determine and perform actions at the property by issuing commands to one or more components of the environment 400, possibly through the control unit 410.

The central alarm system 470 is an electronic device, or multiple electronic devices, configured to provide alarm monitoring service by exchanging communications with the control unit 410, the one or more mobile devices 440 and 450, the monitoring system 460, or a combination of these, over the network 405. For example, the central alarm system 470 can be configured to monitor alerting events generated by the control unit 410. In these examples, the central alarm system 470 can exchange communications with the network module 414 included in the control unit 410 to receive information regarding alerting events detected by the control unit 410. The central alarm system 470 can receive information regarding alerting events from the one or more mobile devices 440 and 450, the monitoring system 460, or both. In some implementations, the central alarm system 470 can be implemented, at least in part if not entirely, on the monitoring system 460. In these implementations, the monitoring system 460 can perform the operations described with reference to the central alarm system 470. One or both of the monitoring system 460 or the central alarm system 470 can be implemented in the cloud.

The central alarm system 470 is connected to multiple terminals 472 and 474. The terminals 472 and 474 can be used by operators to process alerting events. For example, the central alarm system 470, e.g., as part of a first responder system, can route alerting data to the terminals 472 and 474 to enable an operator to process the alerting data. The terminals 472 and 474 can include general-purpose computers (e.g., desktop personal computers, workstations, or laptop computers) that are configured to receive alerting data from a computer in the central alarm system 470 and render a display of information using the alerting data.

For instance, the controller 412 can control the network module 414 to transmit, to the central alarm system 470, alerting data indicating that a sensor 420 detected motion from a motion sensor via the sensors 420. The central alarm system 470 can receive the alerting data and route the alerting data to the terminal 472 for processing by an operator associated with the terminal 472. The terminal 472 can render a display to the operator that includes information associated with the alerting event (e.g., the lock sensor data, the motion sensor data, the contact sensor data, etc.) and the operator can handle the alerting event based on the displayed information. In some implementations, the terminals 472 and 474 can be mobile devices or devices designed for a specific function. Although FIG. 4 illustrates two terminals for brevity, actual implementations can include more (and, perhaps, many more) terminals.

The one or more devices 440 and 450 are devices that can present content, e.g., host and display user interfaces, audio data, or both. For instance, the mobile device 440 is a mobile device that hosts or runs one or more native applications (e.g., the smart property application 442). The mobile device 440 can be a cellular phone or a non-cellular locally networked device with a display. The mobile device 440 can include a cell phone, a smart phone, a tablet PC, a personal digital assistant (“PDA”), or any other portable device configured to communicate over a network and present information. The mobile device 440 can perform functions unrelated to the monitoring system, such as placing personal telephone calls, playing music, playing video, displaying pictures, browsing the Internet, and maintaining an electronic calendar.

The mobile device 440 can include a smart property application 442. The smart property application 442 refers to a software/firmware program running on the corresponding mobile device that enables the user interface and features described throughout. The mobile device 440 can load or install the smart property application 442 using data received over a network or data received from local media. The smart property application 442 enables the mobile device 440 to receive and process image and sensor data from the monitoring system 460.

The device 450 can be a general-purpose computer (e.g., a desktop personal computer, a workstation, or a laptop computer) that is configured to communicate with the monitoring system 460, the control unit 410, or both, over the network 405. The device 450 can be configured to display a smart property user interface 452 that is generated by the device 450 or generated by the monitoring system 460. For example, the device 450 can be configured to display a user interface (e.g., a web page) generated using data provided by the monitoring system 460 that enables a user to perceive images captured by the camera 430, reports related to the monitoring system, or both. Although FIG. 4 illustrates two devices for brevity, actual implementations can include more (and, perhaps, many more) or fewer devices.

In some implementations, the one or more devices 440 and 450 communicate with and receive data from the control unit 410 using the communication link 438. For instance, the one or more devices 440 and 450 can communicate with the control unit 410 using various wireless protocols, or wired protocols such as Ethernet and USB, to connect the one or more devices 440 and 450 to the control unit 410, e.g., local security and automation equipment. The one or more devices 440 and 450 can use a local network, a wide area network, or a combination of both, to communicate with other components in the environment 400. The one or more devices 440 and 450 can connect locally to the sensors and other devices in the environment 400.

Although the one or more devices 440 and 450 are shown as communicating with the control unit 410, the one or more devices 440 and 450 can communicate directly with the sensors and other devices controlled by the control unit 410. In some implementations, the one or more devices 440 and 450 replace the control unit 410 and perform one or more of the functions of the control unit 410 for local monitoring and long range, offsite, or both, communication.

In some implementations, the one or more devices 440 and 450 receive monitoring system data captured by the control unit 410 through the network 405. The one or more devices 440 and 450 can receive the data from the control unit 410 through the network 405, the monitoring system 460 can relay data received from the control unit 410 to the one or more devices 440 and 450 through the network 405, or a combination of both. In this regard, the monitoring system 460 can facilitate communication between the one or more devices 440 and 450 and various other components in the environment 400.

In some implementations, the one or more devices 440 and 450 can be configured to switch whether the one or more devices 440 and 450 communicate with the control unit 410 directly (e.g., through communication link 438) or through the monitoring system 460 (e.g., through network 405) based on a location of the one or more devices 440 and 450. For instance, when the one or more devices 440 and 450 are located close to, e.g., within a threshold distance of, the control unit 410 and in range to communicate directly with the control unit 410, the one or more devices 440 and 450 use direct communication. When the one or more devices 440 and 450 are located far from, e.g., outside the threshold distance of, the control unit 410 and not in range to communicate directly with the control unit 410, the one or more devices 440 and 450 use communication through the monitoring system 460.

Although the one or more devices 440 and 450 are shown as being connected to the network 405, in some implementations, the one or more devices 440 and 450 are not connected to the network 405. In these implementations, the one or more devices 440 and 450 communicate directly with one or more of the monitoring system components and no network (e.g., Internet) connection or reliance on remote servers is needed.

In some implementations, the one or more devices 440 and 450 are used in conjunction with only local sensors and/or local devices in a house. In these implementations, the environment 400 includes the one or more devices 440 and 450, the sensors 420, the module 422, the camera 430, and the robotic devices 490. The one or more devices 440 and 450 receive data directly from the sensors 420, the module 422, the camera 430, the robotic devices 490, or a combination of these, and send data directly to the sensors 420, the module 422, the camera 430, the robotic devices 490, or a combination of these. The one or more devices 440 and 450 can provide the appropriate interface, processing, or both, to provide visual surveillance and reporting using data received from the various other components.

In some implementations, the environment 400 includes network 405 and the sensors 420, the module 422, the camera 430, the thermostat 434, and the robotic devices 490 are configured to communicate sensor and image data to the one or more devices 440 and 450 over network 405. In some implementations, the sensors 420, the module 422, the camera 430, the thermostat 434, and the robotic devices 490 are programmed, e.g., intelligent enough, to change the communication pathway from a direct local pathway when the one or more devices 440 and 450 are in close physical proximity to the sensors 420, the module 422, the camera 430, the thermostat 434, the robotic devices 490, or a combination of these, to a pathway over network 405 when the one or more devices 440 and 450 are farther from the sensors 420, the module 422, the camera 430, the thermostat 434, the robotic devices 490, or a combination of these.

In some examples, the monitoring system 460 leverages GPS information from the one or more devices 440 and 450 to determine whether the one or more devices 440 and 450 are close enough to the sensors 420, the module 422, the camera 430, the thermostat 434, the robotic devices 490, or a combination of these, to use the direct local pathway or whether the one or more devices 440 and 450 are far enough from the sensors 420, the module 422, the camera 430, the thermostat 434, the robotic devices 490, or a combination of these, that the pathway over network 405 is required. In some examples, the monitoring system 460 leverages status communications (e.g., pinging) between the one or more devices 440 and 450 and the sensors 420, the module 422, the camera 430, the thermostat 434, the robotic devices 490, or a combination of these, to determine whether communication using the direct local pathway is possible. If communication using the direct local pathway is possible, the one or more devices 440 and 450 communicate with the sensors 420, the module 422, the camera 430, the thermostat 434, the robotic devices 490, or a combination of these, using the direct local pathway. If communication using the direct local pathway is not possible, the one or more devices 440 and 450 communicate with the sensors 420, the module 422, the camera 430, the thermostat 434, the robotic devices 490, or a combination of these, using the pathway over network 405.

In some implementations, the environment 400 provides people with access to images captured by the camera 430 to aid in decision-making. The environment 400 can transmit the images captured by the camera 430 over a network, e.g., a wireless WAN, to the devices 440 and 450. Because transmission over a network can be relatively expensive, the environment 400 can use several techniques to reduce costs while providing access to significant levels of useful visual information (e.g., compressing data, down-sampling data, sending data only over inexpensive LAN connections, or other techniques).

In some implementations, a state of the environment 400, one or more components in the environment 400, and other events sensed by a component in the environment 400 can be used to enable/disable video/image recording devices (e.g., the camera 430). In these implementations, the camera 430 can be set to capture images on a periodic basis when the alarm system is armed in an “away” state, set not to capture images when the alarm system is armed in a “stay” state or disarmed, or a combination of both. In some examples, the camera 430 can be triggered to begin capturing images when the control unit 410 detects an event, such as an alarm event, a door-opening event for a door that leads to an area within a field of view of the camera 430, or motion in the area within the field of view of the camera 430. In some implementations, the camera 430 can capture images continuously, but the captured images can be stored or transmitted over a network when needed.

Although FIG. 4 depicts the monitoring system 460 as remote from the control unit 410, in some examples the control unit 410 can be a component of the monitoring system 460. For instance, both the monitoring system 460 and the control unit 410 can be physically located at a property that includes the sensors 420 or at a location outside the property.

In some examples, some of the sensors 420, the robotic devices 490, or a combination of both, might not be directly associated with the property. For instance, a sensor or a robotic device might be located at an adjacent property or on a vehicle that passes by the property. A system at the adjacent property or for the vehicle, e.g., that is in communication with the vehicle or the robotic device, can provide data from that sensor or robotic device to the control unit 410, the monitoring system 460, or a combination of both.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

1. A computer-implemented method comprising:
accessing i) data for a detected event that was detected using first sensor data captured by a first sensor at a property and ii) second sensor data captured by a second sensor at the property, the first sensor having a different type than the second sensor;
providing, to an artificial intelligence model trained to determine whether to provide a notification about the detected event, the data for the detected event and the second sensor data to cause the artificial intelligence model to generate output;
receiving, from the artificial intelligence model, the output that indicates whether to provide a notification about the detected event; and
performing one or more actions using the output that indicates whether to provide a notification about the detected event.

2. The method of claim 1, comprising:
receiving, from the first sensor, the data for the detected event; and
in response to receiving the data for the detected event, requesting the second sensor data.

3. The method of claim 2, wherein requesting the second sensor data comprises:
in response to receiving the data for the detected event, triggering the second sensor to initiate capture of the second sensor data; and
in response to triggering the second sensor to initiate capture of the second sensor data, receiving, from the second sensor, the second sensor data.

4. The method of claim 2, comprising:
in response to receiving the data for the detected event, determining a type of the first sensor data or a type of the event;
determining whether the type satisfies a type criterion; and
in response to determining that the type satisfies the type criterion, triggering the second sensor to provide the second sensor data to a system that communicates with the artificial intelligence model.

5. The method of claim 1, wherein performing the one or more actions comprises determining to skip providing a notification in response to determining that the output indicates that a notification about the detected event should not be provided.

6. The method claim 1, wherein performing the one or more actions comprises:
determining an alert for the detected event; and
sending, to a device for the property, instructions to cause the device to present the alert.

7. The method of claim 6, wherein receiving the output comprises receiving the output that indicates the alert for the detected event.

8. The method of claim 7, wherein receiving the output comprises receiving the output that indicates an audible alert for the detected event.

9. The method of claim 7, wherein receiving the output comprises receiving the output that indicates a procedurally generated alert for the detected event.

10. The method of claim 7, wherein receiving the output comprises receiving the output that indicates a predetermined alert from a plurality of predetermined alerts.

11. The method of claim 6, comprising:
determining, from a plurality of presentation devices for the property, a proper subset of presentation devices for presentation of the alert, wherein sending the instructions comprises sending the instructions to each device in the proper subset of presentation devices that includes the device.

12. The method of claim 11, wherein receiving the output that indicates whether to provide a notification comprises receiving the output that indicates the proper subset of presentation devices for presentation of the alert.

13. The method of claim 1, wherein performing the one or more actions comprises sending, to a device for the property, instructions to cause the device to perform one or more actions to mitigate a likely impact of the detected event.

14. The method of claim 13, wherein sending the instructions comprises sending, to a device, instructions to cause the device to perform at least one of shutting a water valve or turning off another device.

15. The method of claim 1, wherein:
accessing the data for the detected event comprises accessing the data that indicates that the detected event that likely has an environmental impact at the property;
providing the data for the detected event and the second sensor data comprises providing, to the artificial intelligence model trained to determine whether to provide a notification about the detected event, the data for the detected event and the second sensor data to cause the artificial intelligence model to generate output that indicates whether to provide a notification about the detected event that likely has an environmental impact at the property; and
receiving the output comprises receiving, from the artificial intelligence model, the output that indicates whether to provide a notification about the detected event that likely has an environmental impact at the property.

16. The method of any preceding claim, wherein a device comprises both the first sensor and the second sensor.

17. The method of any preceding claim, in which the artificial intelligence model simulates a smart sensor of the type of the first sensor.

18. The method of any preceding claim, wherein the data for the detected event comprises one or more of the first sensor data or event data that identifies the detected event.

19. A system comprising one or more computers and one or more storage devices on which are stored instructions that are operable, when executed by the one or more computers, to cause the one or more computers to perform operations comprising:
maintaining, for an event type at a property, a prompt that represents an event subtype of the event type, a predetermined output, and data that identifies a predetermined action to perform upon detection of the event subtype;
receiving, upon detection of an event of the event type using sensor data captured by a sensor for the property, the sensor data;
providing, to an artificial intelligence model trained to determine whether to provide a notification about the event, the sensor data for the event and the prompt to cause the artificial intelligence model to generate output for the event subtype;
receiving, from the artificial intelligence model, the output that indicates a response to the prompt;
determining whether the output satisfies a similarity criterion for the predetermined output and to perform the predetermined action for the event; and
performing an action using a result of the determination whether the output satisfies the similarity criterion for the predetermined output and to perform the predetermined action for the event.

20. One or more computer storage media encoded with instructions that, when executed by one or more computers, cause the one or more computers to perform operations comprising:
accessing i) data for a detected event that was detected using first sensor data captured by a first sensor at a property and ii) second sensor data captured by a second sensor at the property, the first sensor having a different type than the second sensor;
providing, to an artificial intelligence model trained to determine whether to provide a notification about the detected event, the data for the detected event and the second sensor data to cause the artificial intelligence model to generate output;
receiving, from the artificial intelligence model, the output that indicates whether to provide a notification about the detected event; and
performing one or more actions using the output that indicates whether to provide a notification about the detected event.
